(19) United States
(12) Patent Application Publication
(10) Pub. No.: US 2021/0064032 A1
(43) Pub. Date: Mar. 4, 2021

(54) METHODS AND SYSTEMS FOR MANEUVER BASED DRIVING

(71) Applicant: GM GLOBAL TECHNOLOGY OPERATIONS LLC, Detroit, MI (US)

(72) Inventors: Claudia V. Goldman-Shenhar, Mevasseret Zion (IL); Gila Kamhi, Zichron Yaakov (IL)

(73) Assignee: GM GLOBAL TECHNOLOGY OPERATIONS LLC, Detroit, MI (US)

(21) Appl. No.: 16/554,727

(22) Filed: Aug. 29, 2019

(51) Int. Cl. G05D 1/00; G06N 20/00

(52) U.S. Cl. CPC G05D 1/0088; H04W 4/46; G06N 20/00

(57) ABSTRACT

Systems and methods are provided for controlling a vehicle. In one embodiment, a method includes: storing, in a data storage device associated with the vehicle, data defining a plurality of modes, wherein the data includes for each mode of the plurality of modes a mode type, at least one vehicle maneuver, and control parameters associated with the at least one vehicle maneuver; dynamically updating, by a processor, at least one of the mode type, the at least one vehicle maneuver, and the control parameters for at least one of the plurality of modes based on user input; and controlling the vehicle based on the dynamically updated mode.

### INTRODUCTION

The present disclosure generally relates to vehicles, and more particularly relates to methods and systems for mapping driving modes to maneuvers performed by an autonomous or semi-autonomous vehicle.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

While autonomous vehicles and semi-autonomous vehicles offer many potential advantages over traditional vehicles, in certain circumstances it may be desirable for improved operation of the vehicles. For example, autonomous vehicles or semi-autonomous vehicle assume a default driving style. Users may prefer that the autonomous vehicle or semi-autonomous vehicle operate according to a driving style similar to their own driving style. Users may also prefer to change the driving style based on various conditions.

Accordingly, it is desirable to provide improved systems and methods for mapping different driving modes to maneuvers of an autonomous or semi-autonomous vehicle in order to allow for different driving styles. Furthermore, other desirable features and characteristics of the present disclosure will become apparent from the subsequent detailed description and the appended claims, taken in conjunction with the accompanying drawings and the foregoing technical field and background.

### SUMMARY

Systems and methods are provided for controlling a vehicle. In one embodiment, a method includes: storing, in a data storage device associated with the vehicle, data defining a plurality of modes, wherein the data includes for each mode of the plurality of modes a mode type, at least one vehicle maneuver, and control parameters associated with the at least one vehicle maneuver; dynamically updating, by a processor, at least one of the mode type, the at least one vehicle maneuver, and the control parameters for at least one of the plurality of modes based on user input; and controlling the vehicle based on the dynamically updated mode.

In various embodiments, the dynamically updating is based on user input received directly from a user of the vehicle.

In various embodiments, the user input includes a selection of at least one of a mode of the plurality of modes and a value of a control parameter associated with the mode.

In various embodiments, the user input includes a selection to disengage a mode and indications of reasons for the disengagement.

In various embodiments, the dynamically updating is based on user input received indirectly from a user of the vehicle.

In various embodiments, the user input includes a sensed user response to a vehicle maneuver.

In various embodiments, the dynamically updating is based on user input received while the vehicle is in route.

In various embodiments, the dynamically updating is based on user input received after the vehicle has completed a route.

In various embodiments, the dynamically updating is based on at least one of environment conditions and vehicle conditions.

In another embodiment a system for controlling a vehicle is provided. The system includes: a first data storage device that stores data defining a plurality of modes, wherein the data includes for each mode of the plurality of modes a mode type, at least one vehicle maneuver, and control parameters associated with the at least one vehicle maneuver; and a processor configured to: dynamically update at least one of the mode type, the at least one vehicle maneuver, and the control parameters for at least one of the plurality of modes based on user input; and control the vehicle based on the dynamically updated mode.

In various embodiments, the processor dynamically updates based on user input received directly from a user of the vehicle.

In various embodiments, the user input includes a selection of at least one of a mode of the plurality of modes and a value of a control parameter associated with the mode.

In various embodiments, the user input includes a selection to disengage a mode and indications of reasons for the disengagement.

In various embodiments, the processor dynamically updates based on user input received indirectly from a user of the vehicle.

In various embodiments, the user input includes a sensed user response to a vehicle maneuver.

In various embodiments, wherein the processor dynamically updates based on user input received while the vehicle is in route.

In various embodiments, the processor dynamically updates based on user input received after the vehicle has completed a route.

In various embodiments, the processor dynamically updates based on environment conditions.

In various embodiments, the processor dynamically updates based on vehicle conditions.

In various embodiments, the processor is further configured to determine the plurality of modes based on crowdsourced vehicle data and a machine learning clustering method.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a mode mapping system, in accordance with various embodiments;

FIG. 2 is a dataflow diagram illustrating an autonomous driving system that includes the mode mapping system, in accordance with various embodiments;

FIG. 3 is a dataflow diagram illustrating a mode mapping system, in accordance with various embodiments;

FIG. 4 is a functional block diagram illustrating a mapped mode, in accordance with various embodiments;

FIG. 5 is a flowchart illustrating a mapping method that may be performed by the mode mapping system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

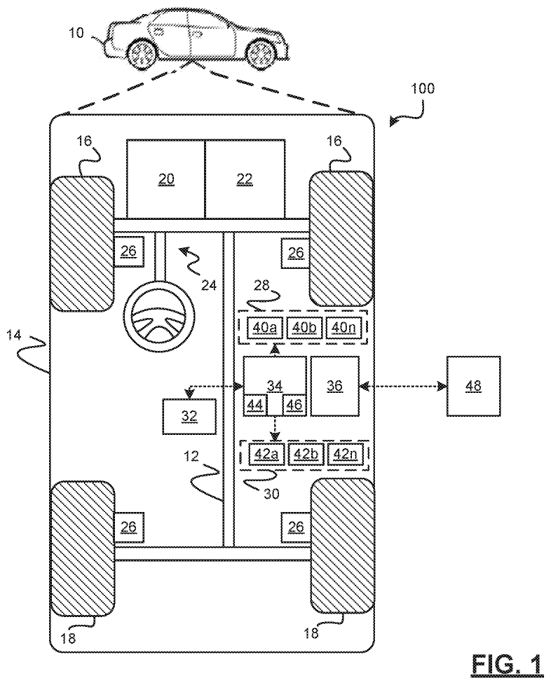

With reference to FIG. 1, a mode mapping system shown generally at 100 is associated with a vehicle 10 in accordance with various embodiments. In general, the mode mapping system 100 dynamically defines modes of operating the vehicle 10 based on various inputs and by mapping modes to certain vehicle maneuvers and certain control parameters associated with the vehicle maneuvers. As will be discussed in more detail below, the mode mapping system 100 allows for autonomously or semi-autonomously controlling the vehicle 10 based on the dynamically determined modes of operation.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the interpretation system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, or simply robots, etc., that are regulated by traffic devices can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. As can be appreciated, in various embodiments, the autonomous vehicle 10 can be any level of automation or have no automation at all (e.g., when the system 100 simply presents the probability distribution to a user for decision making).

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. In various embodiments, the sensing devices 40a-40n include one or more image sensors that generate image sensor data that is used by the interpretation system 100.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

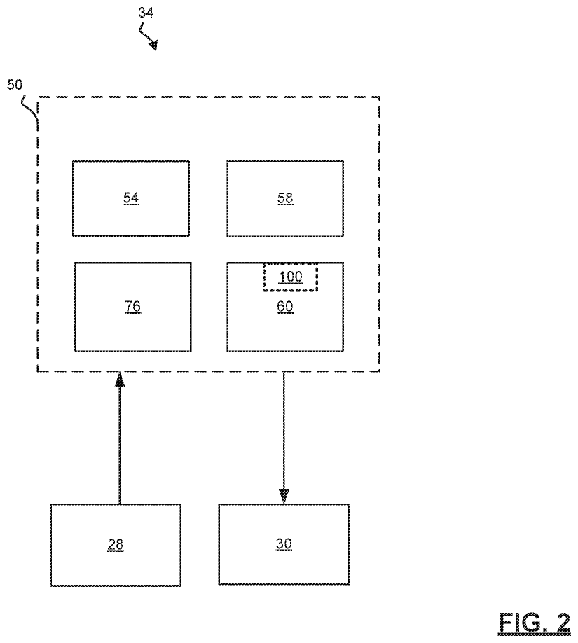

The communication system 36 is configured to wirelessly communicate information to and from other entities 48, such as but not limited to, other vehicles (“V2V” communication) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps are built from the sensor data of the vehicle 10. In various embodiments, the maps are received from a remote system and/or other vehicles. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the mode mapping system 100 and, when executed by the processor 44, dynamically defines modes based on various inputs by mapping a mode to vehicle maneuvers and control parameters, and controls the vehicle 10 based on the defined modes.

As can be appreciated, the controller 34 may be implemented as multiple controllers including at least one residing on the vehicle and at least one residing remote from the vehicle. In such embodiments, functions of the system 100 may implemented on any of the controllers 34, including partially on a first controller of the vehicle and partially on a second controller residing for example on a server system.

As can be appreciated, the subject matter disclosed herein provides certain enhanced features and functionality to what may be considered as a standard or baseline non-autonomous vehicle or an autonomous vehicle 10, and/or an autonomous vehicle based remote transportation system (not shown) that coordinates the autonomous vehicle 10. To this end, a non-autonomous vehicle, an autonomous vehicle, and an autonomous vehicle based remote transportation system can be modified, enhanced, or otherwise supplemented to provide the additional features described in more detail below. For exemplary purposes the examples below will be discussed in the context of an autonomous vehicle.

In accordance with various embodiments, the controller 34 implements an autonomous driving system (ADS) 50 as shown in FIG. 2. That is, suitable software and/or hardware components of the controller 34 (e.g., the processor 44 and the computer-readable storage device 46) are utilized to provide an autonomous driving system 50 that is used in conjunction with vehicle 10.

In various embodiments, the instructions of the autonomous driving system 50 may be organized by function, module, or system. For example, as shown in FIG. 2, the autonomous driving system 50 can include a computer vision system 54, a positioning system 56, a guidance system 58, and a vehicle control system 60. As can be appreciated, in various embodiments, the instructions may be organized into any number of systems (e.g., combined, further partitioned, etc.) as the disclosure is not limited to the present examples.

In various embodiments, the computer vision system 54 synthesizes and processes sensor data and predicts the presence, location, classification, and/or path of objects and features of the environment of the vehicle 10. In various embodiments, the computer vision system 54 can incorporate information from multiple sensors, including but not limited to cameras, lidars, radars, and/or any number of other types of sensors.

The positioning system 56 processes sensor data along with other data to determine a position (e.g., a local position relative to a map, an exact position relative to lane of a road, vehicle heading, velocity, etc.) of the vehicle 10 relative to the environment. The guidance system 58 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, the mode mapping system 100 of FIG. 1 may be included within the ADS 50, for example, as part of the vehicle control system 80.

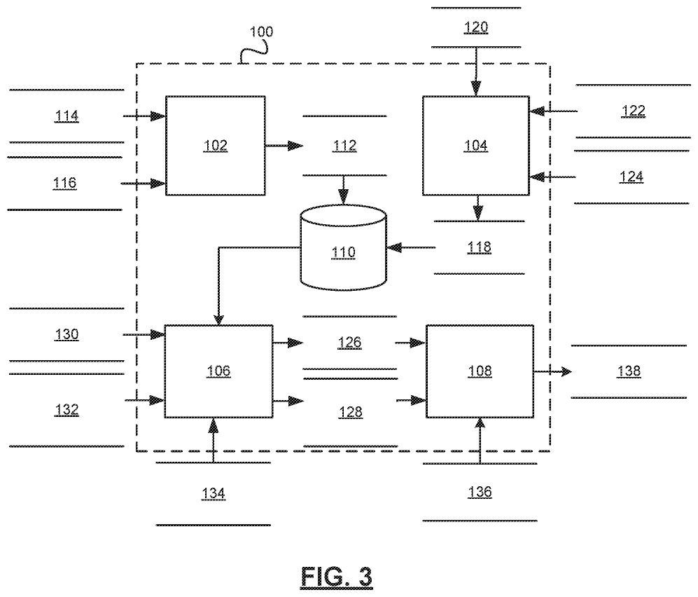

As shown in more detail with regard to FIG. 3 and with continued reference to FIGS. 1 and 2, the mode mapping system 100 may be implemented as a plurality of functional modules. As can be appreciated, the functional modules shown and described may be combined or further partitioned in various embodiments. A shown the modules include a mode mapping module 102, a mode updating module 104, a mode selection module 106, a maneuver control module 108, and a mode data datastore 110.

The mode mapping module 102 determines modes of operation to be offered by the vehicle 10. The mode mapping module 102 stores the determined modes as mode data 112 in the mode data datastore 110 for future use. In various embodiments, the mode mapping module 102 maps to each mode a mode type, one or more vehicle maneuvers associated with the mode type, and control parameters and parameter values associated with the one or more vehicle maneuvers.

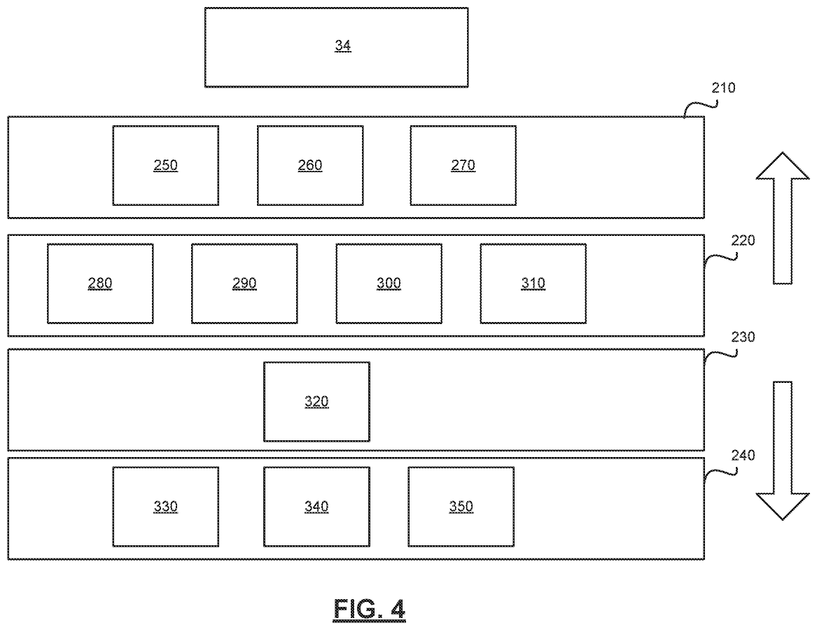

In various embodiments, the mode mapping module 102 determines the modes based on predefined data 114. For example, the modes can be defined to include, but not limited to, a default mode, a comfort mode, and a sport mode. For example, as shown in FIG. 4, each of these modes can be defined to include layers 210-240 relating to control actions, maneuvers, routing, and services. For example, certain services 330-350, such as, but not limited, parking, charging or fueling, transportation availability and locations may be included in the services layer 240 associated with the mode. In another example, certain routing 320 such as, but not limited to, navigation may be included in the routing layer 230. In another example, certain maneuvers 280-310 such as, but not limited to, turning, cornering, lane change, merging, exiting, parking, or any other vehicle maneuver that may be autonomously or semi-autonomously performed may be included within the maneuver layer 220. In another example, certain control actions and parameters 250-270 associated with each maneuver can be predefined and can include, but are not limited to speed, acceleration, braking, steering commands, lane position, gap distance, and/or any other control parameter used to define how a maneuver is performed. The values of the control parameters can include average values associated with default operation of the vehicle 10, values associated with operation of the vehicle 10 for user comfort, and values associated with operation of the vehicle 10 for a sporty ride.

With reference back to FIG. 3, in various embodiments, the mode mapping module 102 determines the modes based on crowdsourced data 116 received from a plurality of other vehicles. In various embodiments, the crowdsourced data 116 can include sensed values or communicated values obtained during various vehicle maneuvers, obtained during various driving conditions, obtained at various times of day, and/or based on any other conditions. The mode mapping module 102 determines the mode data 112 by collecting the data 116 from multiple vehicles, and clustering the data 116 into three or more clusters using one or more machine learning clustering methods. The mode mapping module 102 then defines each cluster as a mode. The mode mapping module 102 then identifies a centroid of each of the clusters and the parameter values associated with the centroids are used as the control parameter values associated with the mode and stored in the mode data datastore 110.

The mode updating module 104 dynamically updates the defined modes by storing updated mode data 118. In various embodiments, the mode updating module 104 dynamically updates the defined modes based on user input data 120 received in response to a user interacting with the vehicle 10 and/or a user interacting with a user interface provided by the vehicle 10 and/or a smart device (e.g., a smart phone, a tablet, a watch, glasses, etc.) associated with the vehicle 10. For example, a user can provide their user input preferences to tune the maneuvers associated with the defined modes and/or to tune the values of the control parameters of the defined modes. The user input can be provided through speech, touch, gestures, in-wheel controls, cluster controllers, tablets, etc.

In various embodiments, the user input can be provided while the vehicle 10 is in operation (online) or after the vehicle 10 has completed a route (offline). For example, a user may select a mode from a plurality of modes presented to them (e.g., via a user interface) while the vehicle 10 is in route. In another example, the user may update control parameters of a current mode by speaking “please brake more slowly” while the vehicle 10 is in route. In another example, the user may request to disengage a selected mode while the vehicle 10 is in route and the mode and/or control parameters may be updated based on user input obtained (e.g., indirectly learned from user behavior or directly learned from user input) after the disengagement.

In various embodiments, the mode updating module 104 dynamically updates the defined modes based on environmental conditions data 122. For example, each mode may be mapped to one or more environmental conditions such as, but not limited to, a road type, a specific road or road segment, traffic conditions associated with the road, weather, or any other condition external to the vehicle 10.

In various embodiments, the mode updating module 104 dynamically updates the defined modes based on vehicle conditions data 124. For example, each mode may be mapped to one or more vehicle conditions such as, but not limited to, vehicle dynamics, or any other condition of the vehicle 10 or occupants of the vehicle 10.

The mode selection module 106 selects a current mode of operation and generates current mode data 126. In various embodiments, the mode selection module 106 determines the current mode of operation based on user selection data 130, current environment conditions data 132, and/or current vehicle conditions data 134. The mode selection module 106 retrieves the mode from the mode data datastore 110 and the mode's associated control parameters and sets the retrieved mode and associated control parameters as the current mode and the current control parameters. For example, a user may select, through a user interface, a particular mode type from a number of offered mode types and the mode selection module 106 retrieves the mode data based on the user selected mode type. In another example, the mode selection module 106 automatically retrieves the mode data based on environment conditions data and/or vehicle conditions data that matches or is similar to the current environment conditions data 132 and/or current vehicle conditions data 134.

The maneuver control module 108 receives the current mode data 126, the associated control parameters data 128, and a maneuver algorithm 136. The maneuver control module 108 performs the algorithms of the desired maneuver using the associated control parameters data 128. As can be appreciated, the maneuver algorithms can be predefined algorithms for controlling the vehicle 10 carry out a particular maneuver. Thus, the maneuver is performed by generating control signals 138 according to the maneuver algorithm and the dynamically mapped control parameters.

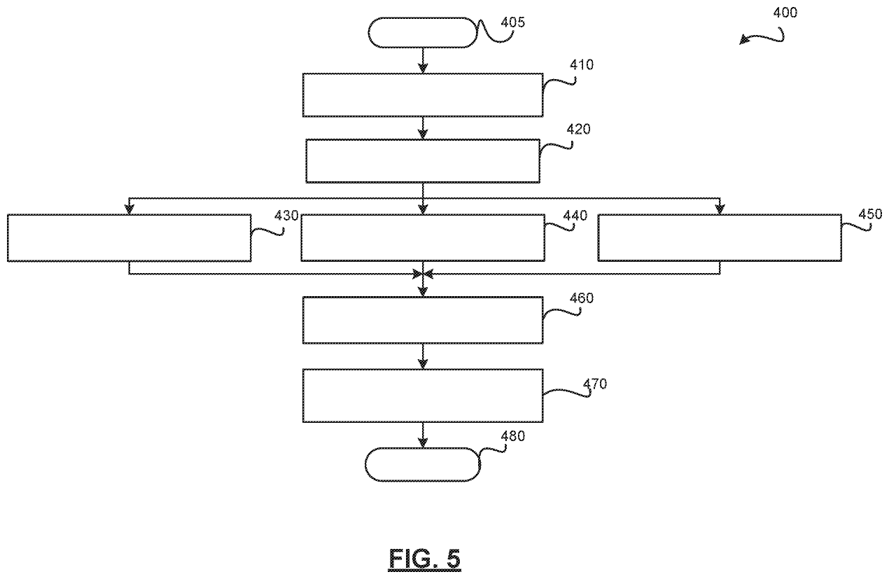

Referring now to FIG. 5 and with continued reference to FIGS. 1-3, a method 400 for mapping modes is shown in accordance with various embodiments. As can be appreciated, in light of the disclosure, the order of operation within the method 400 is not limited to the sequential execution as illustrated in FIG. 5 but may be performed in one or more varying orders as applicable and in accordance with the present disclosure. In various embodiments, one or more steps of the method 400 may be removed or added without altering the spirit of the methods 400.

In one embodiment, the method 400 may begin at 405. The modes are mapped at 410. For example, the modes are defined to include a mode type and one or more vehicle maneuvers. The vehicle maneuvers each are defined to include one or more control parameters. The control parameters are defined to be associated with a control value. In various embodiments, the mode type, the vehicle maneuvers, and/or the control parameters are defined based on predefined data values (e.g., initial calibrations) or are defined based on crowdsourced vehicle data and machine learning clustering methods as discussed above. Once the modes are defined, the mode data 112 is stored in the mode datastore 110 at 420.

Thereafter, user input 120 is received at 430, environment conditions data 122 is received at 440, and/or vehicle conditions data 124 is received at 450 as discussed above. At 460, one or more of the stored modes (e.g., mode type, associated driving maneuvers, control parameters) are updated and stored at 470 in the mode data datastore 100 based on the user preferences, the environment conditions, and/or the vehicle conditions. Thereafter, the method may end at 480.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling a vehicle, comprising:
storing, in a data storage device associated with the vehicle, data defining a plurality of modes, wherein the data includes for each mode of the plurality of modes a mode type, at least one vehicle maneuver, and control parameters associated with the at least one vehicle maneuver;
dynamically updating, by a processor, at least one of the mode type, the at least one vehicle maneuver, and the control parameters for at least one of the plurality of modes based on user input; and
controlling the vehicle based on the dynamically updated mode.

2. The method of claim 1, wherein the dynamically updating is based on user input received directly from a user of the vehicle.

3. The method of claim 2, wherein the user input includes a selection of at least one of a mode of the plurality of modes and a value of a control parameter associated with the mode.

4. The method of claim 2, wherein the user input includes a selection to disengage a mode and indications of reasons for the disengagement.

5. The method of claim 1, wherein the dynamically updating is based on user input received indirectly from a user of the vehicle.

6. The method of claim 5, wherein the user input includes a sensed user response to a vehicle maneuver.

7. The method of claim 1, wherein the dynamically updating is based on user input received while the vehicle is in route.

8. The method of claim 1, wherein the dynamically updating is based on user input received after the vehicle has completed a route.

9. The method of claim 1, wherein the dynamically updating is based on at least one of environment conditions and vehicle conditions.

10. A system for controlling a vehicle, comprising:
a first data storage device that stores data defining a plurality of modes, wherein the data includes for each mode of the plurality of modes a mode type, at least one vehicle maneuver, and control parameters associated with the at least one vehicle maneuver; and
a processor configured to:
dynamically update at least one of the mode type, the at least one vehicle maneuver, and the control parameters for at least one of the plurality of modes based on user input; and
control the vehicle based on the dynamically updated mode.

11. The system of claim 10, wherein the processor dynamically updates based on user input received directly from a user of the vehicle.

12. The system of claim 11, wherein the user input includes a selection of at least one of a mode of the plurality of modes and a value of a control parameter associated with the mode.

13. The system of claim 11, wherein the user input includes a selection to disengage a mode and indications of reasons for the disengagement.

14. The system of claim 10, wherein the processor dynamically updates based on user input received indirectly from a user of the vehicle.

15. The system of claim 14, wherein the user input includes a sensed user response to a vehicle maneuver.

16. The system of claim 10, wherein the processor dynamically updates based on user input received while the vehicle is in route.

17. The system of claim 10, wherein the processor dynamically updates based on user input received after the vehicle has completed a route.

18. The system of claim 10, wherein the processor dynamically updates based on environment conditions.

19. The system of claim 10, wherein the processor dynamically updates based on vehicle conditions.

20. The system of claim 10, wherein the processor is further configured to determine the plurality of modes based on crowdsourced vehicle data and a machine learning clustering method.
